(19) United States
(12) Patent Application Publication
(10) Pub. No.: US 2009/0310342 A1
(43) Pub. Date: Dec. 17, 2009

(54) Flashlight with Wireless Video Camera

(76) Inventor: Hung-Yi CHANG, Fongyuan City (TW)

Correspondence Address: SINORICA, LLC, 2275 Research Blvd., Suite 500, ROCKVILLE, MD, 20850, US

(21) Appl. No.: 12/140,347

(22) Filed: Jun. 17, 2008

(51) Int. Cl. F21L 4/00; H04N 3/14

(52) U.S. Cl. 362/205; 348/294; 348/E03.001

(57) ABSTRACT

A flashlight includes a flashlight comprising a battery compartment having a space for containing a rechargeable electrical energy source, a wireless transmitting circuit, and a recharging unit; a switch assembly mounted on the battery compartment and comprising an illumination switch and a video taking switch; a head assembly comprising a video camera, a light assembly, and a light sensor; and an antenna. The video taking switch is adapted to press to either (i) activate the video camera if the illumination switch is closed or (ii) enable the sensor to activate the light assembly and activate the video camera if the illumination switch is open. Pictures taken by the video camera are transformed into electrical signals prior to sending to the antenna for transmission via the wireless transmitting circuit.

### BACKGROUND OF THE INVENTION

1. Field of Invention

The invention relates to flashlights and more particularly to such a flashlight adapted to serve as a wireless video camera in addition to illumination.

2. Description of Related Art

Flashlights are typically only for illumination. However, some people may be not satisfied with such typical flashlights. For instance, when a suspect is found or an incident is occurred in a dark environment, it is typical for a policeman to hold a flashlight with one hand and hold a camera with the other hand so that a clear picture of the suspect or the incident can taken. However, this means that the policeman does not have a free hand to use a gun for defense. This is very dangerous for the policeman. Thus, the need for improvement still exists.

### SUMMARY OF THE INVENTION

It is therefore one object of the invention to provide a flashlight adapted to serve as a wireless video camera in addition to illumination.

To achieve the above and other objects, the invention provides a flashlight comprising a battery compartment having an internal space for containing a rechargeable electrical energy source, a wireless transmitting circuit, and a recharging unit; a switch assembly mounted on the outer surface of the battery compartment and comprising an illumination switch and a video taking switch; a head assembly comprising a video camera, a light assembly, and a light sensor; and an antenna; wherein the video taking switch is adapted to press to either (i) activate the video camera if the illumination switch is closed or (ii) enable the sensor to activate the light assembly and activate the video camera if the illumination switch is open; and wherein pictures taken by the video camera are transformed into electrical signals prior to sending to the antenna for transmission via the wireless transmitting circuit.

The above and other objects, features and advantages of the invention will become apparent from the following detailed description taken with the accompanying drawings.

### BRIEF DESCRIPTION OF THE DRAWINGS

FIG. 1 is a perspective view of a preferred embodiment of flashlight with a wireless video camera according to the invention;

FIG. 2 is a longitudinal sectional view of FIG. 1;

FIG. 3 is an enlarged view of the head assembly of FIG. 2; and

FIG. 4 is a block diagram illustrating a video taking and wireless video transmission operation of the flashlight.

### DETAILED DESCRIPTION OF THE INVENTION

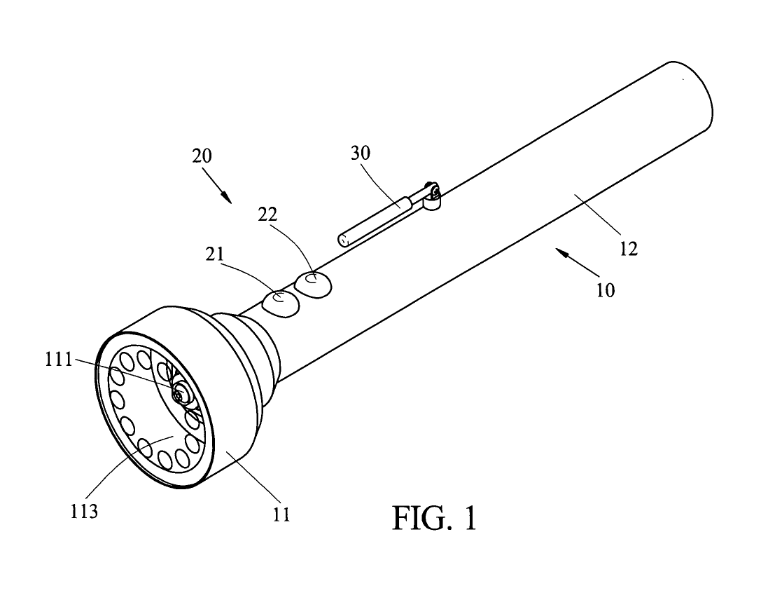

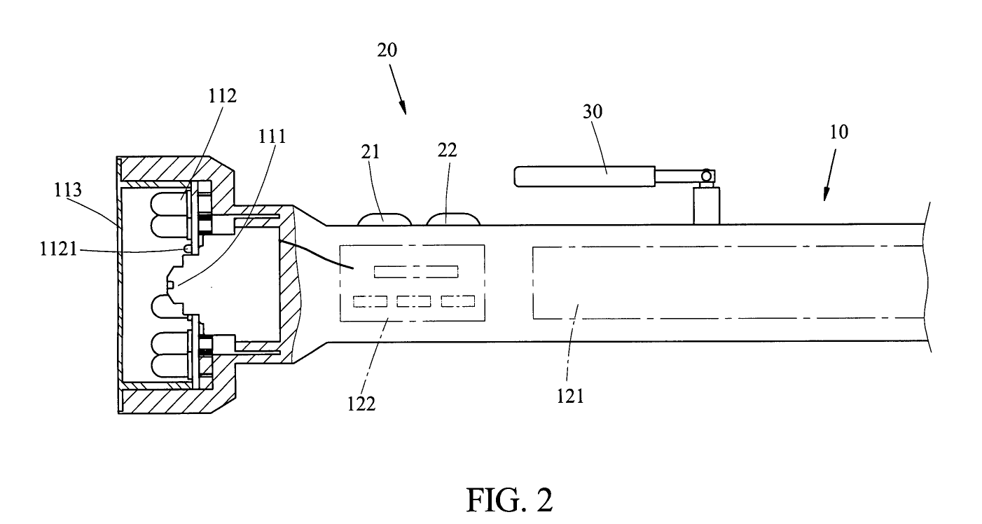

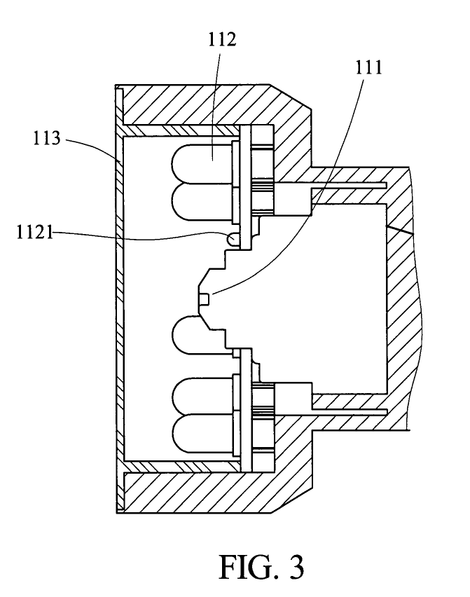

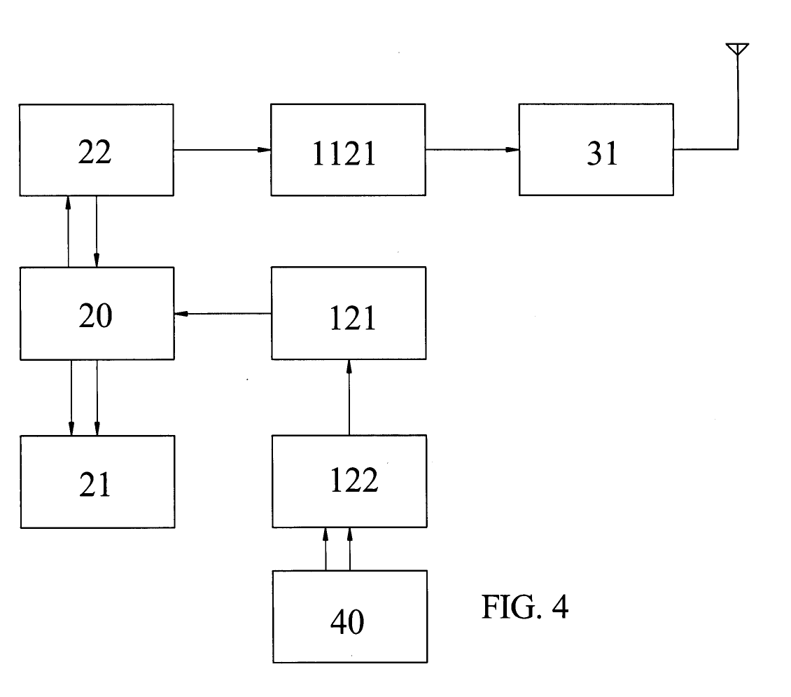

Referring to FIGS. 1 to 4, a flashlight in accordance with a preferred embodiment of the invention is generally designated by numeral 10. The flashlight 10 comprises the following components as discussed in detail below.

A cylindrical battery compartment 12 has an internal space for mounting a rechargeable cell 121 and a recharging circuit 122 which is electrically connected to a battery charging plug 40 (not shown in FIGS. 1 to 3). An individual may connect the battery charging plug 40 to, for example, a wall outlet to charge the rechargeable cell 121 via the recharging circuit 122 if the rechargeable cell 121 is discharged.

A switch assembly 20 is mounted on the outer surface of the battery compartment 12 and comprises an illumination switch 21 and a video taking switch 22 both being push button type switches.

A head assembly 11 comprises a central video camera 111, a light assembly 112 including a plurality of LEDs (light-emitting diodes) surrounding the video camera 111 and a light sensor 1121, and a front lens 113. Preferably, the video camera 111 is implemented as a charge-coupled device (CCD) lens or a complementary metal-oxide semiconductor (CMOS) lens.

A joining portion of the head assembly 11 and the battery compartment 12 is tapered toward the battery compartment 12.

A pivotal antenna 30 is also mounted on the outer surface of the battery compartment 12 behind the switch assembly 20. The antenna 30 is in signal communication with the sensor 1121 via a wireless transmitting circuit 31 (not shown in FIGS. 1 to 3).

The switch assembly 20, the video camera 111, the rechargeable cell 121, and the light assembly 112 are electrically connected together.

An individual may press the illumination switch 21 to activate the LEDs of the light assembly 112 to emit light rays for illumination as known in the art.

A video taking and wireless video transmission operation of the invention, i.e., characteristics of the invention, will be described in detail below.

An individual may press the video taking switch 22 irrespective of the illumination switch 21 being activated or not. A video taking operation of the flashlight is activated directly to cause the video camera 111 to take pictures through the lens 113 if the illumination switch 21 has been pressed for illumination (i.e., the ambient light is sufficient)

Alternatively, the sensor 1121 is enabled to activate the LEDs of the light assembly 112 to emit light rays if the illumination switch 21 has not been pressed. That is, the sensor 1121 is adapted to sense brightness of the environment. The video camera 111 may begin to take pictures through the lens 113 if the ambient light is sufficient.

The taken pictures are transformed into electrical signals by the video camera 111 and the signals are in turn sent to the wireless transmitting circuit 31. Finally, the signals are sent out via the antenna 30 in the form of radio waves. A specific base station is adapted to receive the video signals to display or store.

While the invention herein disclosed has been described by means of specific embodiments, numerous modifications and variations could be made thereto by those skilled in the art without departing from the scope and spirit of the invention set forth in the claims.

What is claimed is:

1. A flashlight comprising:
a battery compartment having an internal space for containing a rechargeable electrical energy source, a wireless transmitting circuit, and a recharging unit;
a switch assembly mounted on the outer surface of the battery compartment and comprising an illumination switch and a video taking switch;
a head assembly comprising a video camera, a light assembly, and a light sensor; and
an antenna;
wherein the video taking switch is adapted to press to either (i) activate the video camera if the illumination switch is closed or (ii) enable the sensor to activate the light assembly and activate the video camera if the illumination switch is open; and
wherein pictures taken by the video camera are transformed into electrical signals prior to sending to the antenna for transmission via the wireless transmitting circuit.

2. The flashlight of claim 1, wherein each of the illumination switch and the video taking switch is a push button type switch.

3. The flashlight of claim 1, wherein the light assembly comprises a plurality of LEDs (light-emitting diodes)

4. The flashlight of claim 3, wherein the video camera is surrounded by the LEDS.

5. The flashlight of claim 1, wherein a joining portion of the head assembly and the battery compartment is tapered toward the battery compartment.

6. The flashlight of claim 1, wherein the video camera is a charge-coupled device (CCD) lens.

7. The flashlight of claim 1, wherein the video camera is a complementary metal-oxide semiconductor (CMOS) lens.
